(19) United States
(12) Patent Application Publication
(10) Pub. No.: US 2007/0129893 A1
(43) Pub. Date: Jun. 7, 2007

(54) Forecasting tool and methodology

(76) Inventors: Colin McColl, Herefordshire (GB); Moray McConnachie, Oxford (GB); Jose Antonio Alvarez Tapia, Oxford (GB); David Reginald Young, Oxfordshire (GB)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 11/291,487

(22) Filed: Dec. 1, 2005

(51) Int. Cl. G06Q 10/00; G06F 19/00

(52) U.S. Cl. 702/19; 705/1

(57) ABSTRACT

A forecasting tool and methodology are described for generating a quantitative index indicating the current state of a system. The system may be affected by a plurality of events. A numerical value, based on the current situation, is assigned to each of a plurality of factors identified as influencing the event. The numerical values are used to calculate a likelihood metric for the event occurring. An impact factor value, which indicates the impact that the event occurring would have on the system, is combined with the likelihood, to calculate the quantitative index. Indexes for different forecasting periods can be calculated using numerical values for different periods of time. A forecasting tool and computer program implementing that tool are also described. The forecasting methodology can be used to provide an index which is published or used internally by an organisation. The forecasting methodology can also be used as the basis of a consulting service provided to an organisation. The forecasting methodology can be used in connection with a wide variety of systems, such as political, industrial, commercial, economic, financial, social, military, security and defence systems.

### FIELD OF THE INVENTION

The present invention relates to forecasting, and in particular to generating quantitative indicia reflecting the state of a system or events influencing a system and which can be used to help monitor the state and/or predict the future state of the system or events. The invention can be used as part of a decision making process and can be used internally by an organisation or provided to an organisation as part of a constancy process.

### BACKGROUND

Medium term forecasting, for example for up to a few years into the future rather than tens of years into the future, is difficult to achieve reliably. Forecasting methodologies which predict that an occurrence will happen can lack credibility if the predicted occurrence fails to materialise. Further, forecasting methodologies which focus mostly on negative occurrences can be unacceptable as psychologically they can reduce confidence which can harm an organisations performance. It can therefore be preferred to use a forecasting methodology based on the likelihood of something happening and which does not focus mostly on negative things happening.

A medium term forecasting method has been presented by one of the inventors which attempts to help forecast a particular event occurring. The method formulates a specific question in terms of the likelihood of a specific event occurring. The main factors likely to make that event occur and the main factors likely to prevent that event occur are identified. Secondary factors capable of strengthening or weakening the main factors are identified. Then a judgement of the likelihood of the specific event occurring is made based on the balance of the main factors. Changes which could effect any of the factors are monitored to see if they would alter the existing balance.

However, this approach focuses on a single event only and therefore reflects the likelihood of that event occurring only. Further it does not consider the consequences of that event occurring. Furthermore, it does not have a rigorous structure or a quantitative approach.

It would therefore be beneficial to provide a forecasting method capable of application to more complex systems. It would also be beneficial if the consequences of events occurring could be assessed in relation to the events or to the system as a whole. It would further be beneficial if a more rigorous methodology were available. It would yet further be beneficial if a more quantitative forecasting approach were available. Any or all of these would provide a tool or tools by which organisations could make more informed forecasting assessments, determine whether corrective action is appropriate and take action to try and lead to a preferred future scenario.

### SUMMARY OF THE INVENTION

The present invention uses a quantitative measure of the likelihood of an event occurring together with an impact factor, reflecting what impact the event occurring would have, so as to provide a numerical value, or index, which characterises the current status of an event. The quantitative measure of the likelihood can be based on at least one, or a plurality, of factors which are considered to influence whether the event will happen or not. The indices for a plurality of different events, each of which is related to a system under consideration, can be combined to provided an overall index for the system. The value and/or variations in the individual event indices or overall system index can be used to help forecast the state of an event, group of events or the system as a whole.

According to a first aspect of the present invention, there is provided a method for creating a quantitative index indicating the current state of a system. The system may be affected by at least one or a plurality of events. A numerical value can be assigned to at least one or each of a plurality of factors identified as influencing the event or events. The numerical value or values can be based on the current situation. The numerical values or values can be used to calculate a likelihood metric for the event occurring. An impact factor value and the likelihood metric can be combined to calculate the quantitative index. The impact factor value can indicate the impact that the event occurring would have either in isolation or on the system as a whole.

The likelihood metric merely provides a numerical value indicative of the likelihood of the event occurring. The likelihood metric does not need to be a probability or a statistical likelihood, but in preferred embodiments, the likelihood metric can be based on probability calculations and or statistical techniques.

The sign of the numerical value can be used to indicate whether the factor drives the event to happen or restrains the event from happening. Using the sign of the numerical value provides a simple mechanism for determining the relative influence of each factor. However, in other embodiments, the numerical values can all have the same sign and can extend over a range of values of the same sign.

The likelihood metric can be calculated using a numerical value generally representing the average numerical value of the events and a numerical value generally representing the spread in numerical value of the events. As used herein the terms “average” and “spread” are not intended to have their strict mathematical meanings, but rather to mean a value characteristic of the middle of the range of values and a value characteristic of the range of values. The likelihood metric can be calculated by dividing the sum of the numerical values for the event by the sum of the absolute value, or modulus, of the values of the numerical values for the event. Preferably it is the sum of the positive numerical values.

Calculating the quantitative index can further include normalising the quantitative index. The quantitative index can be normalised by dividing the quantitative index value by the maximum possible value that the index could have to generate a normalised index. The maximum possible value can correspond to the value of the index if all of the events occurred.

The quantitative index can also be normalised by dividing the quantitative index value by the value that the index could have if a subset of all of the events occurred. The subset of all of the events can be those events considered to be most important events. The most important events can be determined by multiplying the impact factor by the likelihood of the event for each event. The most important events can then be identified by thresholding that value against a threshold value so that only those events meeting or exceeding the threshold value are considered to be most one of the most important events.

Calculating the quantitative index can include multiplying the impact factor value and likelihood for each of the plurality of events.

The method can further comprise monitoring the current situation and/or identifying changes in the current situation which require or may require numerical values for any of the factors for any of the events to be updated. The method can further comprise updating numerical values. The quantitative index can be recalculated using the updated numerical values. Alternatively or additionally, the quantitative index can be recalculated using updated impact factor values.

The method can further comprise monitoring the system and/or identifying events to add or remove from the set of events constituting the index. The quantitative index can be recalculated using an updated set of events.

The current situation and/or factors and/or events and/or index can be monitored on a regular basis or a periodic basis. For example, the frequency of monitoring can be monthly, weekly, daily or on an hourly basis.

Monitoring the current situation can include consulting with an expert or experts in a field or fields relevant to the event or events. Consulting can include having at least one expert or experts in a field relevant to at least one of the events assess the current situation. The expert or experts can be selected from the group comprising: academics; journalists; industrialists; government officials; government advisers; businessmen; financiers; bankers; economists; social scientists; politicians; political scientists; scientists; economists; intelligence, defence, security or military personnel; lawyers; and similar and any combinations thereof.

The method can further comprise assigning at least one further numerical value, or a plurality of further numerical values, to each of the plurality of factors. The or each of the further numerical values can be used to calculate a longer term likelihood and/or a shorter term likelihood of the event occurring. An impact factor value can be combined with the longer term likelihood, and/or shorter term likelihood, to calculate at least one further quantitative index, or a plurality of further quantitative indices. Different impact factor values can be used for different terms of likelihood.

The method can further comprise assigning a numerical value to each of a plurality of sub-factors identified as influencing at least a one, a group or all of the factors. The sub factors can be considered to be sub-drivers or sub-restrainers for the driver or restrainer factor. This allows a more detailed or finer grained analysis of the system to be carried out. A lower level, or levels, of drivers or restrainers for the sub level can also be used. The numerical value for the factor can be determined from the numerical values for the sub factors, and similarly for any lower levels of factors. The numerical value for the factor can be provided by summing the values assigned to the sub-factors, and preferably the numerical value for the factor is provided by calculating the average of the values assigned to the sub-factors.

According to a further aspect of the invention, there is provided a computer implemented method for creating a quantitative index indicating the current state of a system. A likelihood metric for at least one, or a plurality of, events occurring can be calculated using numerical values assigned to each factor, or factors, identified as influencing each event. The numerical values can be based on a current situation. An impact factor value assigned to each events can be combined with each likelihood metric to provide an impact metric for each of the events. The impact factor value can indicate the impact that the event occurring would have on the system. The quantitative index can be calculated by combining the impact metrics for all of the events.

Each numerical values can have a sign. The sign can indicates whether the factor drives the event to happen or restrains the event from happening.

Calculating the likelihood metric can include dividing the sum of the numerical values for the event by the sum of the absolute value, or modulus, of the numerical values for the event.

Calculating the quantitative index can further include normalising the quantitative index. Normalising the quantitative index can include using a metric of the maximum impact on the system if all of the events occurred. Calculating the quantitative index can include multiplying the impact factor value and likelihood for each of the plurality of events.

The method can further comprise recalculating the quantitative index using updated numerical values, wherein the updated numerical values relate to any of the factors for any of the events which have been updated to reflect changes in the current situation. The method can further comprise recalculating the quantitative index using updated impact factor values and/or updated sets of events which constitute the index.

The method can further comprise for at least one of said plurality of events, assigning at least a further numerical value to each of the plurality of factors identified as influencing the event. The further numerical values can be used to calculate a longer term likelihood and/or a shorter term likelihood of the event occurring. An impact factor value and the longer term likelihood and/or shorter term likelihood can be used to calculate a further quantitative index. Multiple different numerical values and/or impact factors can be used to calculate multiple different indices for multiple different periods of time in the future. The period of time in the future can be months or years. Preferably at least one of the periods of time in the future are at least one year. Preferably, the periods of time in the future can be one, two , three, four, or five years, although longer periods of time can also be used.

According to a further aspect of the invention, there is provided a data processing apparatus for creating a quantitative index indicating the current state of a system which may be affected by at least one events. The data processing apparatus can include at least one data processing device and at least one storage device. The storage device can store computer program instructions which can configure the data processing apparatus to carry out a number of operations. A likelihood metric for each of the plurality of events occurring can be calculated using numerical values assigned to each of at least one factor identified as influencing the event. The numerical values can be based on the current situation. An impact factor value assigned to each event can be combined with the likelihood of each event to provide an impact metric for each of the events. The impact factor value can indicate the impact that the event occurring would have on the system. The quantitative index can be calculated by combining the impact metrics for each of the events.

According to a further aspect of the invention, there is provided a computer program product comprising at least one computer readable medium bearing computer program instructions for creating a quantitative index indicating the current state of a system which may be affected at least one event. The computer program instructions can comprise computer program instructions to: calculate a likelihood metric for each event occurring using numerical values assigned to each of at least one factor identified as influencing the event. The numerical values can be based on the current situation. Instructions can also be provided to combine an impact factor value assigned to each event and the likelihood of each event to provide an impact metric for each event. The impact factor value can indicate the impact that the event occurring would have on the system. Instructions to calculate the quantitative index by combining the impact metrics for all of the events can also be provided.

According to a further aspect of the invention, there is provided a method for creating a quantitative index reflecting the current global economic state. The global economic state can be affected by a plurality of events. The method can comprise assigning a numerical value to each of a plurality of factors identified as influencing the event. The numerical values can be based on the current situation. The numerical values can be used to calculate a likelihood metric for the event occurring.

An impact factor value and the likelihood metric can be combined for each event to calculate the quantitative index. The impact factor value can indicate the impact that the event occurring would have on the global economic state.

The method can further comprise monitoring the current situation on a periodic basis. Monitoring can further comprise identifying any changes which may require any of the numerical values for any of the factors for any of the events to be updated. Monitoring may further comprising identifying events which may need adding or removing from the set of events constituting the index. Monitoring may further comprise identifying impact factor values which may need changing.

Monitoring the current situation can be part of a periodic editorial process for a publication relating to the global political or economic situation. The periodic process may be daily. The publication can be an online publication. The online publication can be published via a web site. The index can also be published via the web site. Information or data relating to the index can be linked on the web site to articles or other written materials published on the web site and relating to the information or data.

The method can further comprise updating the numerical values identified as requiring updating. The method can further include recalculating the quantitative index using the updated numerical values. The method can further comprise updating the set of events constituting the index and/or recalculating the quantitative index using the updated set of events. The method can further comprise updating the impact factor values and/or recalculating the quantitative index using the updated impact factor values.

The method can further comprise publishing online an article or written materials relating to the change in the current situation which required the numerical value and/or events and/or impact factor value to be updated.

The method can further comprise: periodically reviewing the current numerical values to identify any numerical values appearing inaccurate; and considering whether to change the numerical values identified as appearing inaccurate. Reviewing may be carried out by a review panel or board.

The method can further comprise identifying a plurality of candidate events which may be relevant to the global economic. Experts can be used to assess and/or advise on the candidate events to identify the plurality of events to be used in determining the quantitative index.

The method can further comprise identifying a plurality of candidate factors which may affect a one of the plurality of events. The plurality of candidate factors can be assessed to identify the plurality of factors to be used in determining the quantitative index.

The method can further comprising publishing the historical changes in the quantitative index. The historical changes in the quantitative index can be published in a graphical form, for example as a line graph.

The method can further comprise assigning at least one further numerical value to each of the plurality of factors identified as influencing the event. The further numerical values can be used to calculate a longer term likelihood and/or a shorter term likelihood of the event occurring. An impact factor value and the longer term likelihood and/or shorter term likelihood can be combined to calculate at least a further quantitative index. Multiple different quantitative indices can be calculated for different periods of time in the future.

According to a further aspect of the invention, there is provided a consulting method for determining a quantitative index reflecting the current state of a system of relevance to an organisation. The organisation is consulted with to identify at least one event which is likely to affect the state of the system. The organisation is consulted with to identify a plurality of factors likely to influence the event. A numerical value is assigned to each of the plurality of factors. The numerical values are used to calculate a likelihood metric for the event occurring. An impact factor value and the likelihood metric are combined to calculate the quantitative index. The impact factor value can indicate the impact that the event occurring would have on the system. The quantitative index can then be reported to the organisation.

The method can further comprise monitoring the current situation to determine if any of the numerical values need updating to more closely reflect the current situation, and if so then updating the numerical values and calculating the quantitative index using the updated numerical values.

The method can further comprise monitoring the index to determine if any of the events need updating, and if so then updating the set of events which constitute the index and calculating the quantitative index using numerical values for the updated set of events.

The method can further comprise monitoring the index to determine if any of the impact factor values need updating, and if so then updating the impact factor values and calculating the quantitative index using the updated impact factor values.

The method can further comprise monitoring changes in the quantitative index and notifying the organisation of any changes in the quantitative index corresponding to a pre-determined criterion.

The predetermined criterion can be selected from the group comprising: the index reaching, exceeding or falling below a threshold value; the index changing by a predetermined amount; the rate of change of the index with time meeting a predetermined value.

The method can further comprise carrying out an ancillary action for the organisation, or by the organisation, in response to any changes in the quantitative index corresponding to a predetermined criterion. The ancillary action can be selected from the group comprising: researching the change in the current situation; analysing the change in the current situation; advising on the change in the current situation; identifying pre-emptive action for the organisation intended to mitigate the change in the quantitative index.

Preferred features of one of the different aspects of the invention can also be preferred features of the other different aspects of the invention.

### BRIEF DESCRIPTION OF THE DRAWINGS

An embodiment of the invention will now be described, by way of example only, and with reference to the accompanying drawings, in which:

FIG. 1 shows a flow chart illustrating the method of the invention at a high level.

FIG. 2 shows a schematic diagram of a computer system in which the invention can be used in a publication environment.

FIG. 3 shows a schematic diagram of a computer system in which the invention can be used in a consulting or internal environment.

FIG. 4 shows a process flow chart illustrating a method of creating an index used in the invention.

FIG. 5 shows an event record data structure used in the invention.

FIG. 6 shows process flow chart illustrating a method of creating an event of the index.

FIG. 7 shows a screen shot of an event editor used in the method illustrated in FIG. 6.

FIG. 8 shows a screen shot of the event editor shown in FIG. 7.

FIG. 9 shows a screen shot of the event editor shown in FIG. 7.

FIG. 10 shows a process flow chart illustrating a method of calculating event likelihoods used in the method illustrated in FIG. 6.

FIG. 11 shows a flow chart illustrating a review part of the method of the invention.

FIG. 12 shows a process flow chart illustrating a publication part of the method of the invention.

FIG. 13 shows a process flow chart illustrating a further publication part of the method of the invention.

FIG. 14 shows a process flow chart illustrating a method of displaying the index.

FIG. 15 shows a process flow chart illustrating a method of calculating the index and used in the method illustrated in FIG. 14.

FIG. 16 shows a screen shot of a web page showing the index being displayed in various formats.

FIG. 17 shows a screen shot of a web page showing an event from the index being displayed in various formats.

FIG. 18 shows a screen shot of a web page showing the same event as shown in FIG. 17 but forecasting further into the future.

FIG. 19 shows a screen shot of a web page showing the history of the event shown in FIGS. 17 and 18 in an overview format.

FIG. 20 shows a screen shot of a web page showing the history of the event shown in FIGS. 17 and 18 in a log format.

FIG. 21 shows a process flow chart illustrating a method of the invention in an internal or consulting environment.

FIG. 22 shows a screen shot of an index analysis tool used in the method illustrated in FIG. 21.

FIG. 23 shows a flow chart illustrating a method of creating an index according to the invention in greater detail.

FIG. 24 shows a flow chart illustrating a monitoring part of the method of the invention.

FIG. 25 shows a flow chart illustrating a review part of the method of the invention.

FIG. 26 shows a flow chart illustrating a consultancy method of the invention.

Similar items in different Figures share common reference numerals unless indicated otherwise.

### DETAILED DESCRIPTION OF PREFERRED EMBODIMENTS

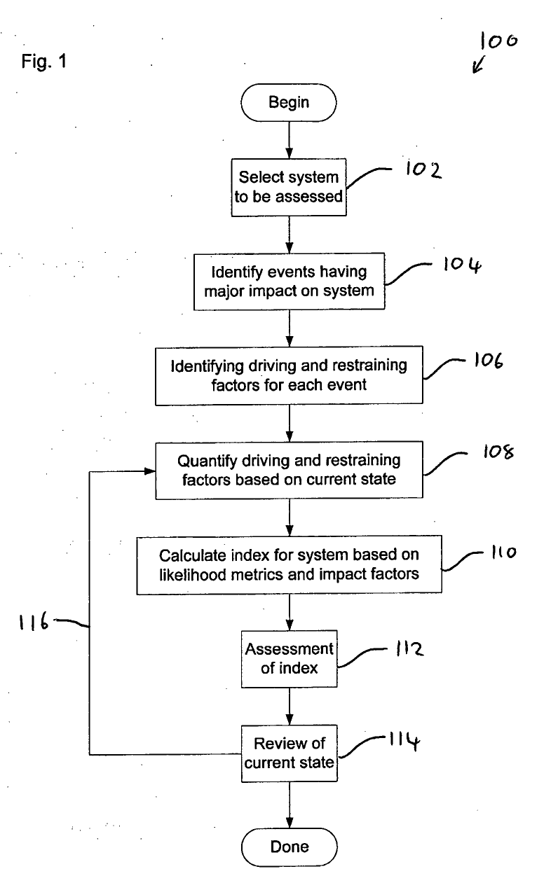

With reference to FIG. 1 there is shown a flowchart illustrating a method 100 which includes creating a quantitative index which can be used to help forecast the state of a system. In the embodiment described herein, the system is an economic or political system and in particular the global economic system. However, it will be appreciated that the method of the current invention can be applied to any complex system in which it is desirable to forecast future trends. For example, the invention can be used in the commercial, industrial, political, economic, financial, military and security fields, as well as combinations or overlapping areas of such fields and other similar complex fields in which forecasting would be beneficial.

An overview will firstly be discussed, before providing a detailed description of a global economic index.

As illustrated in FIG. 1, the method 100 begins by selecting 102 the system for which an index is to be created to help assess the future state of the system. Then at step 104, at least one event likely to effect the system is identified. Preferably, multiple events likely to have significant effect on the system are identified. Preferably each event is defined in terms of the likelihood of a specific event occurring. For example, if the system being assessed were energy markets, than an event may be “what is the likelihood of the price of a barrel of oil rising above US$100?”. Another event may be “what is the likelihood of an electric car being brought to market?”.

After the events have been identified in terms of specific questions, then at step 106, those factors likely to significantly affect the event are identified for each of the events. As used herein, the term “driver” will be used to refer to a factor when it tends to make an event occur. The term “restrainer” will be used to refer to a factor which tends to prevent an event from occurring. A factor may also be neutral depending on the current value assigned to it, as will be further explained in greater detail below.

Once the driving and restraining factors have been identified, at step 108, a numerical value is assigned to each factor based on the current state or situation of the real world. Positive values indicate that the factor is a driver and negative values indicate that the factor is a restrainer. A zero value indicates that the factor currently has no effect. The greater the magnitude of the absolute value, the greater the effect of the factor on the event. Returning to the above example, a factor relating to the event of the price of a barrel of oil exceeding $100, may be the discovery of a new large oil reserve. If that were to occur then that factor would be considered a restrainer as it would decrease the likelihood of the price of a barrel of oil exceeding $100. Another factor may be the occurrence of a natural disaster which closed a current oil supply. This factor would be a driver as it would tend to increase the cost of a barrel of oil. The magnitude of the value assigned to each of these factors is determined based on research and analysis of the current state of the world, for example, the past history of incidences of natural disasters effecting oil production and the past history of oil discovery.

Then at step 1 10, an index for the system is calculated based on the measure of the likelihood of any of the events occurring and an impact factor which provides a quantitative measure of the likely impact of that event on the system under consideration. In the current example, the cost of a barrel of oil exceeding US$100 may have a large impact on the energy markets and therefore, would be assigned a large impact factor. Whereas, the impact of an electric car being brought to market may have a relatively low impact on energy markets, in which case that event would be assigned a lower impact factor. Details of calculating the index from the event likelihoods and impact factors will be described in greater detail below.

At step 112, the index for the system can be assessed. When an index is calculated for the first time, then the full predictive power is not yet provided by the index, but a measure of the current state of the system is provided. However, at step 1 14, the current situation or state of the real world is reviewed and, as illustrated by return line 1116, the method returns to step 108 at which it is determined whether the quantitative values of the factors should be updated based on the current real world situation. For example, if an oil exploration company has recently announced the acquisition of drilling rights with the intention to carry out test drilling in a new area, then the quantitative value for the new oil source discovery factor might be updated to indicate there is an increased likelihood of the discovery of a new source of oil. Similarly, if a company announced the cessation of an electric vehicle research program, then the quantitative value of the associated factor might be updated accordingly.

Additionally, or alternatively, factors may be added or removed at step 108, if it has become apparent that different factors should be included for any of the events or that factors previously associated with an event were not relevant, or are no longer relevant. Quantitative values can also be assigned to any newly added factors at step 108.

It is also generally possible to add or remove events from the set of events constituting the index, for example if it becomes apparent that an important event was missed from the initial set of events or if an event was included which turns out not to be as important as first believed. The index is then recalculated at step 1 10 to reflect the changes in the likelihood of the events occurring. If the events constituting the index have also been changed, then the re-calculated value of the index will also reflect those changes. Then at step 112, the effect of the changes on the overall index can be assessed to determine whether the trend in the index is significant so as to allow future action to be contemplated based on the variation in the index.

The process can then be repeated indefinitely and the index value tracked in order to help assess the future behaviour of the system under consideration, in this instance, the energy market.

Having given an overview of the creation of an index and its use in a forecasting methodology, a detailed description of a global economic index will now be given. The following description will also discuss different environments in which the forecasting methodology can be used. Generally, three environments will be referred to: a “publication” environment; an “internal” or “analysis” environment; and a “consultancy” environment. In the publication environment the index is generated and administered by organisation which publishes or otherwise makes the index available to third parties, on a fee or no fee basis. In the internal or analysis environment, the index is generated internally by an organisation and used by the organisation for its own analytical and forecasting purposes. In the consultancy environment, the index is created for an organisation by a consulting party for the benefit of the organisation and not for general publication or dissemination.

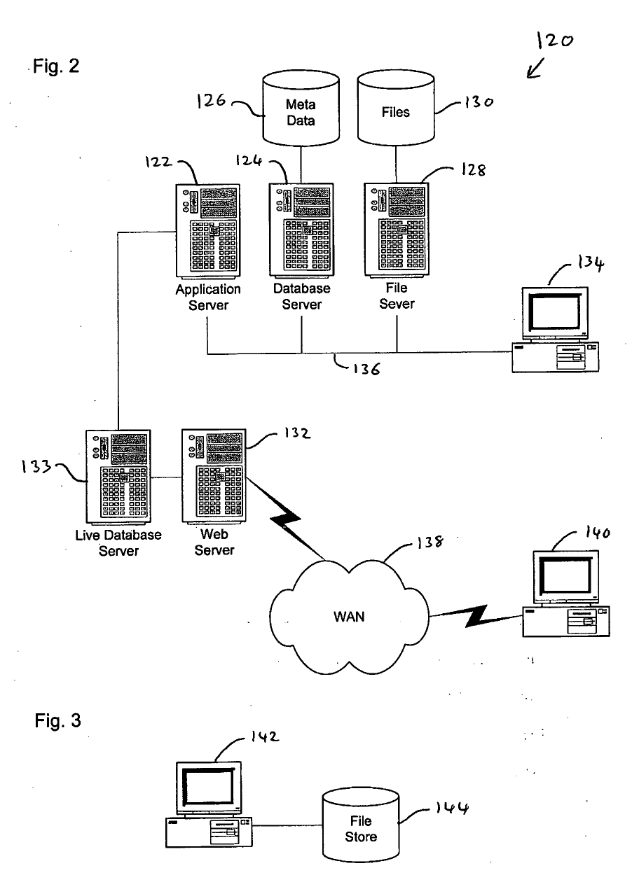

With reference to FIG. 2, there is shown a computer system 120 which can be used to provide the publication environment in which the present invention can be utilised. Computer system 120 includes an application server 122 which generally handles publication of the index. A database server 124 is also provided, in communication with a database 126 which stores metadata relating to the data items used to create the index. A file server 128 is also provided with access to a file store 130 storing the files and data used to create the index and various other data items published in association with the index. A live database server is also provided which handles publication of live event records. A web server 132 is also provided in communication with live database server 133 for publishing information over a wide area network 138, such as the internet or worldwide web part thereof. A client computer 134 is also provided by which a user can interact with the computer system to input the data required for creation of the index. The servers and client computer 134 are connected by a local area network 136 via which data and files are communicated between the machines as required. Software implementing the method described herein can be built using the .NET environment as provided by Microsoft Corporation.

When the index and ancillary information has been published by web server 132, a third party may access the information via computer 140 using a suitable browser application.

FIG. 3 shows an alternate computer system which can be used to provide the internal or consulting environment. The system includes computer 142 and file store 144. File store 144 stores the data required to generate the index and any ancillary information associated with the index. An application runs locally on the operating system of computer 142. The application running on computer 142 carries out a number of the procedures which will be described in greater below with reference to the publication environment illustrated by FIG. 2. However, there is no need to provide public access to the index. Therefore the internal or consultancy environment only needs to be able to generate the index, allow the index to be updated and allow the index to be output for review or analysis purposes. The index value and associated data can be delivered as required, for example by email or over computer network (not shown in FIG. 3).

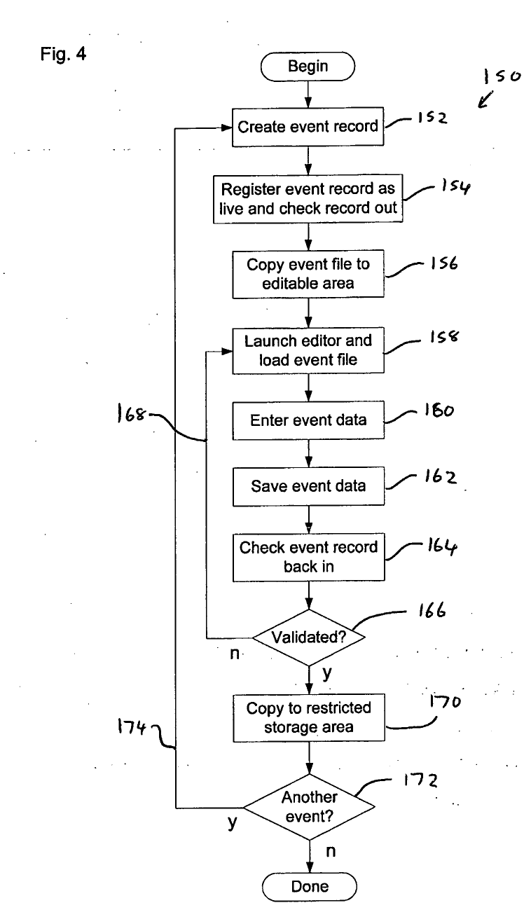

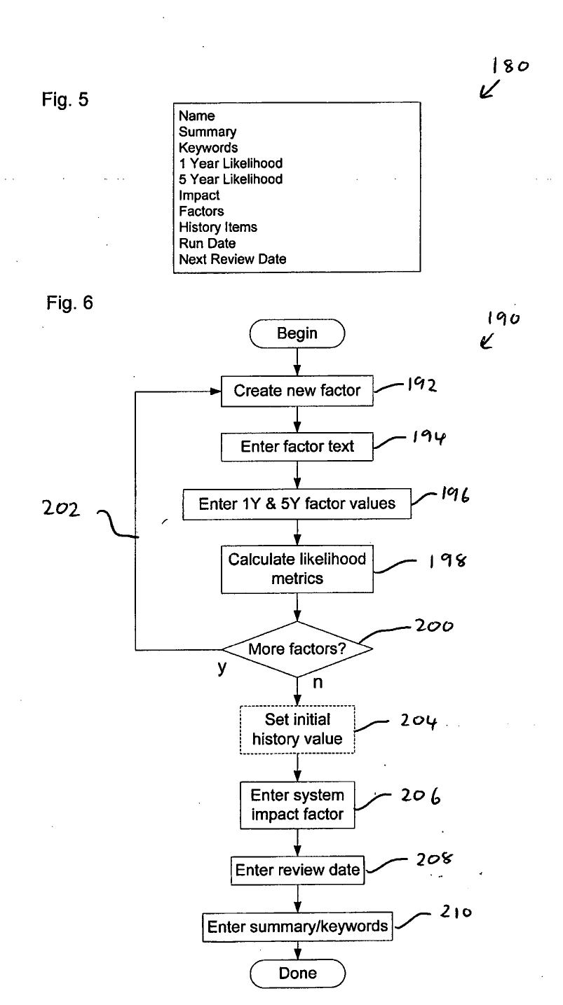

Focussing now on the publication environment, FIG. 4 shows a process flowchart illustrating a method 150 for creating an index. In the exemplary embodiment being described, the index is a global economic index. Computer implemented method 150 begins at step 152 by a user entering a command into client computer 134 indicating that a record for an event of the index is to be created. As step 152 a process running on application server 122 creates a new event record, as illustrated by data structure 180 shown in FIG. 5. When created, each event record 180 is stored as an XML file in the file store 130 by the file server 128.

Each event record 180, includes a number of fields. A name field is provided for storing data items representing the name of the event. A summary field is provided for storing data items providing a text summary of the event. A keywords field is provided for storing data items representing certain keywords associated with the event. A one year likelihood field is provided for storing a data item representing the likelihood of the event occurring within a one year time frame. A five year likelihood field is provided for storing a data item representing the likelihood of the event occurring within a five year time frame. An impact field is provided for storing a data item representing the degree of impact of the event occurring on the system. A factors field is provided for storing a number of data items, each of which represents the numerical value of the factors influencing the event, and which are referred to herein as drivers and restrainers. A history items field is also provided storing data which allows a link to be provided between an updated likelihood value, or a change in impact factor value, and a written analysis that elaborates on the causes that lead to the change. A run date field is provided storing a data item indicating the date on which the likelihoods were last calculated for the event. A next review date field is also provided storing a data item representing the next date at which the values of the factors should be reviewed.

Returning to FIG. 4, a name for the new event record is entered by the user and a creation date is assigned to the event record by application server 122. Then the application server registers that the event record is live and flags are set in the file store 130 and in database 126 indicating that the event record has been checked out to be worked on. Then at step 156, the file server copies the file for the event record from a protected area of storage to an area of storage in which the event record can be written to or otherwise edited.

It will be appreciated that in the internal and consulting model, a less complex approach is adopted in which the user simply creates a new event record in file store 144. However the following steps of method 150 illustrated in FIG. 4 apply similarly to the publication environment and the consultancy and internal environments.

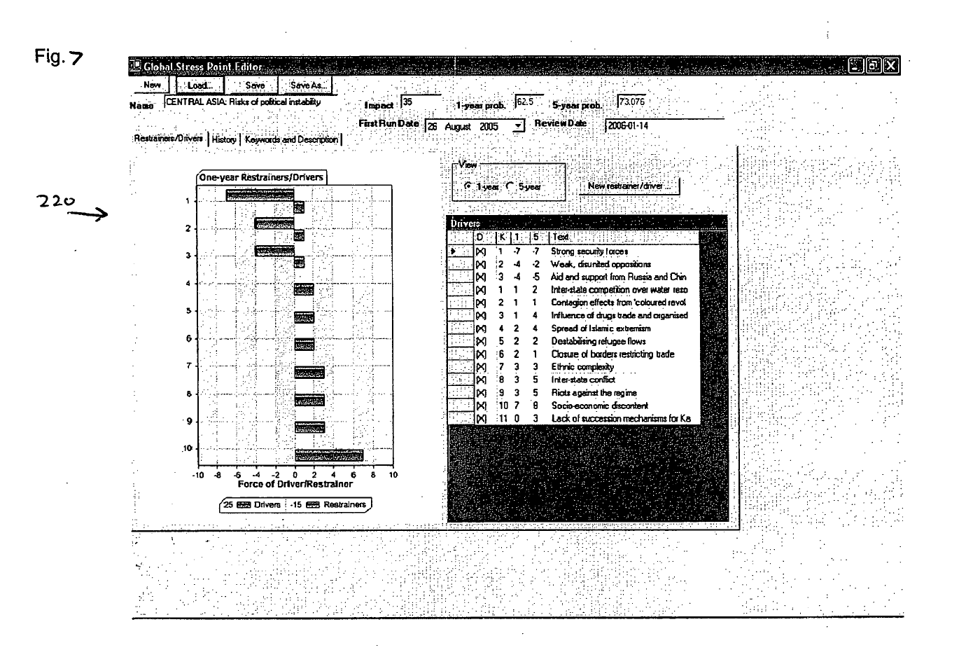

At step 158 an editor application is launched and the event file to be edited is loaded into memory. Then at step 160 data is entered into the event record to create the event file. Use of the editor to create the event file is illustrated in greater detail in FIG. 6. FIGS. 7, 8 and 9 show screen shots of the event editor in restrainer/driver data entry 220, history data entry 230 and key word and descriptor data entry 240 modes respectively. A new restrainer/driver button is operated to enter a command to create a new factor at step 192. Text describing the factor is entered at step 194, e.g. “strong security forces”. Then at step 196 a numerical value representing the effect of this factor on the event for a one year in the future time frame is entered. The numerical value has a magnitude and a sign. A positive sign indicates that the factor is a driver, i.e. is considered to make the event more likely to happen. A negative sign means that the factor is a restrainer, i.e. that the factor makes the event less likely to happen. The magnitude of the factor indicates the current strength of the factor based on the current situation or state of affairs.

The use of signs provides a convenient mechanism to distinguish between drivers and restrainers. However, as it is the relative value which is more important, in other embodiments a scoring system can be used in which all values have the same sign and in which drivers and restrainers are simply at different ends of a scale of values.

Taking the event illustrated in FIG. 7, namely risks of political instability in central Asia, the factor of “strong security forces” has been assigned a value of −7 for one year into the future, reflecting that security forces are currently considered to be strong and this would restrain the likelihood of political instability. At step 196 a value for the factor for five years into the future is also entered. In the example as illustrated in FIG. 7, the five year factor value is also -7.

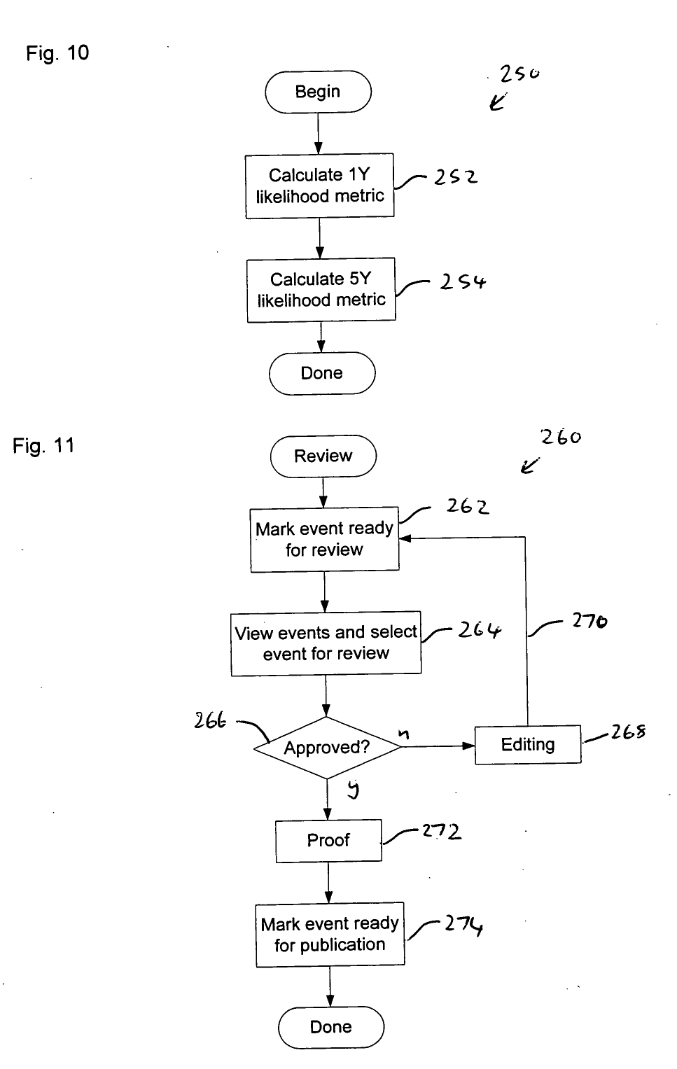

After the one year and five year factor values have been entered at step 198, a measure of the likelihood of the event occurring is dynamically calculated using the method 250 illustrated in FIG. 10. At step 252 a quantitative value or metric, reflecting the likelihood of the event occurring, based on the factors that have been entered to date is calculated. The likelihood metric is calculated by summing all the one year values for the drivers (i.e. factors having positive values) that have been entered and dividing them by the sum of the absolute values of the one year factors. This metric generally represents an average of the factors expressed as a proportion of the range of the values of the factors.

As the default probability density function, a uniform distribution is used. However, in other embodiments, different distributions can be used. In other embodiments the likelihood metric can be obtained using different probability density functions. In practice, the likelihood is calculated by summing the drivers, which have positive numerical values. The sum of the drivers is then divided by the sum of the drivers minus the sum of the restrainers. As the restrainers all have negative values, subtraction of the negative values adds the values of the restrainers to the values of the drivers and so in effect is a sum of the absolute values of the drivers and restrainers. The likelihood obtained in this way can be expressed as a percentage.

Alternatively, or additionally, at least one, or a plurality, of the drivers or restrainers can be broken down into its own drivers and/or restrainers. That is, for any of the factors, the sub-drivers and sub+ restrainers for that factor can be identified and assigned numerical values. Then the average of the values of the sub-drivers and sub-restrainers is used as the numerical value for the corresponding factor. For example, if a factor has three sub-factors having sub-driver values of 4 and 6 and a sub-restrainer value of −7, then the numerical value of the factor is 1, i.e. (4+6+(−7))/3. It is also possible to use further levels of drivers and restrainers, depending on the level of detail required in order to appropriately analyse the system.

Once the one year likelihood metric has been calculated at step 252, then the five year likelihood metric is calculated using the current five year values that have been entered in the same way at step 254.

Returning to FIG. 6, after the likelihood metrics have been calculated at step 198, processing proceeds to step 200 at which it is determined whether more factors are to be added for the current event. If so, then processing returns to step 192, as illustrated by process flow line 202 and a new factor is created and one year and five year values entered and the likelihood metric recalculated at step 198. Processing proceeds in this way until step 200 at which it is determined that there are no more factors to be created for the event.

When an event is first created, then step 204 is used to enter an initial or an “earlier” value for the likelihood which provides a first historical value with which the actual calculated value and likelihood can be compared to illustrate the historical progress of the index. It will be appreciated that step 204 is not required after the event record has initially been set up as thereafter there will always be a preceding value calculated from the preceding values of the drivers and restrainers.

Then at step 206 a value for the impact factor of the event is entered, the impact factor is a number on a scale running from 0 to 100 which reflects the impact that the event would have on the system under consideration if the event were to occur. As illustrated in FIG. 7, an impact factor of 35 has been assigned, indicating that central Asian political instability would have a relatively low impact on the overall global economic situation.

Then at step 208 a review date is entered. The review date is used as part of a review process to ensure that the numerical values for the factors relating to the event are periodically reviewed to ensure their suitability as will be described in greater detail below.

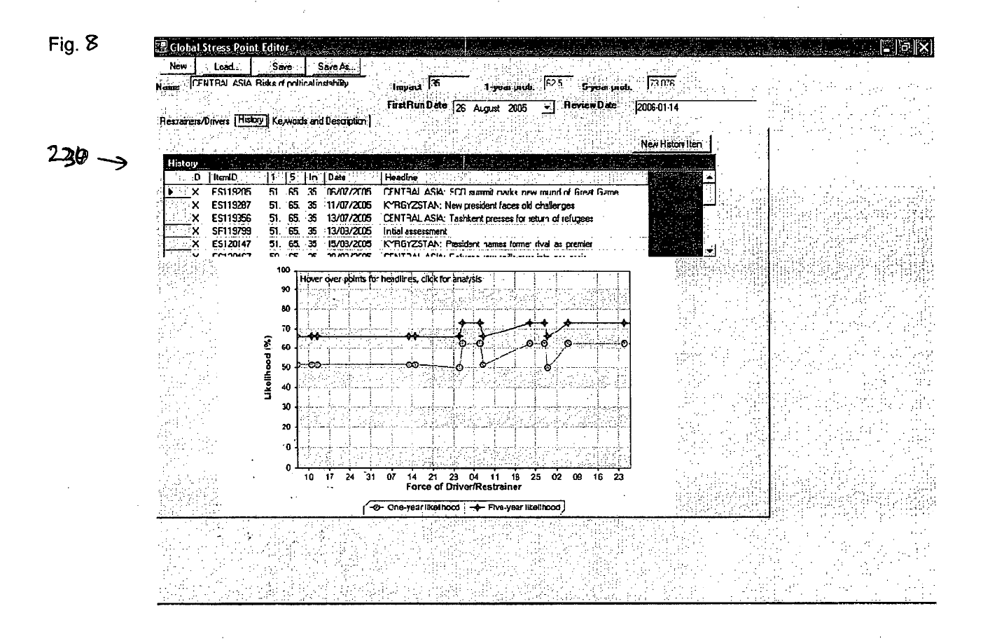

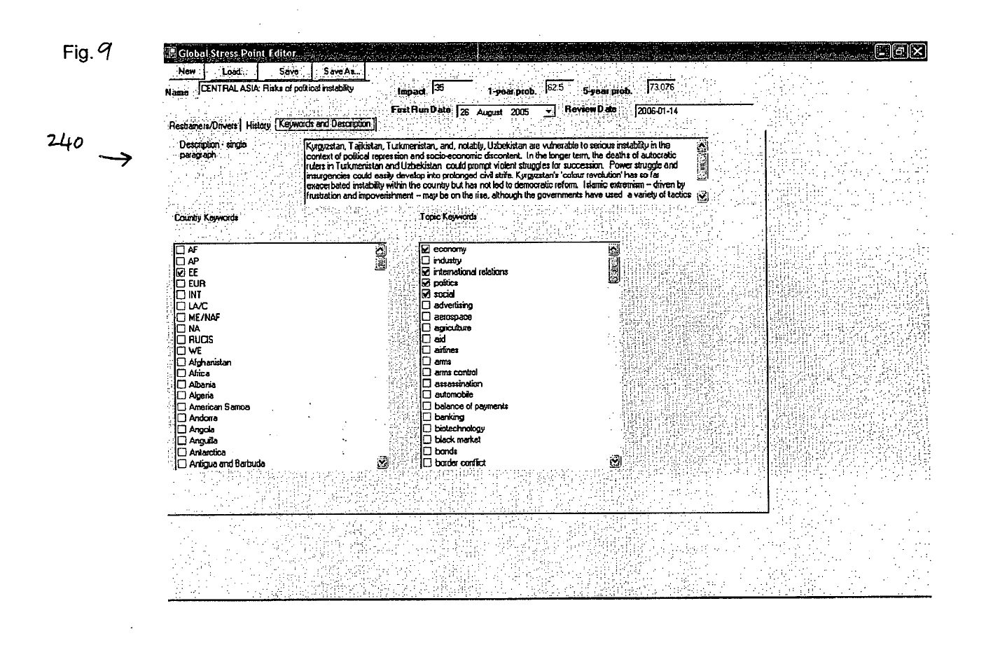

Although not illustrated in FIG. 6, by selecting a history tab, the user of the event editor can enter information regarding the time line of changes to the likelihood and impact, which can be linked to more detailed analysis where appropriate. This can be used to display a graphical representation of the history of the likelihood of the event using one year and/or five year values as illustrated in FIG. 8, discussed below.

Then at step 210, text can be entered providing a summary of the event. Data can also be entered associating certain keywords with the particular event. As illustrated in FIG. 9, a list of country keywords can be provided which can be checked by a user to associate the event with a particular country. A list of topic keywords can also be provided which a user can check one or more of, to associated certain topic keywords with the event. After the summary and keyword information has been entered at step 210, entry of the event record data is completed and processing returns to step 162 of FIG. 4 at which the user enters a command to save the event data. The newly entered data is saved in XML format over the previously existing XML data in the event record file. The event record data is transmitted over network 136 to the application server 122 which sets a flag indicating that the event record file has been checked back into the system.

At step 166, a validation process is carried out on the data. If the data does not validate then processing returns, as illustrated by line 168, to step 158 and the user can re-enter various data items, as required. If the data is determined to have validated at step 166, then processing proceeds to step 170 at which the data file is copied from the editable area of the file store to the non-editable area of the file store at which it is stored as an XML file for future use. An XML schema is provided which establishes the rules for each record and the validation criteria used by the validation process at step 166. If a command is entered indicating that there is another event to be included in the index, then processing returns, as illustrated by return line 174, to step 152 and a new record is created for the new event as described above. When all the events required for the index have been created, then the initial data creation phase of the method ends.

Metadata relating to the event record, such as the author of the event record, reviewers of the event data, people who have modified the event data, people who had proofed the event record and have published the event record is stored in database 126. The metadata also includes the keywords for each event record. The keywords can be by sector and/or by country or region.

With reference to FIG. 11 there is shown a process flowchart illustrating an initial event record review process 260 which is carried out prior to inclusion of the event record in the index. The review process is generally handled by processes occurring on the application server. At step 262, a web browser is used to set a flag indicating that the event record has been completed and is ready for review. At step 264, a web browser is used to view the events available for review and select a one year event record for review. A reviewer then reviews the event record to ensure that the numerical values appear appropriate. The reviewer may be an expert in the field or somebody else having a detailed knowledge of the event who can make a judgement as to whether the relative values of the drivers and restrainers are accurate. If at step 266 it is determined that the event record is inaccurate, then at step 268, the event record can be edited by either the reviewer or another party using the event editor as described above with reference to FIGS. 6 to 9. After the event record has been edited then processing returns to step 262 and the event record is again made available for review.

When the event record has been approved for publication, then processing proceeds to step 272 at which the text data is proof read for publication. Any corrections are made and then at step 274 a flag is set on the application server marking the event record as ready for publication at step 274. The review process then ends.

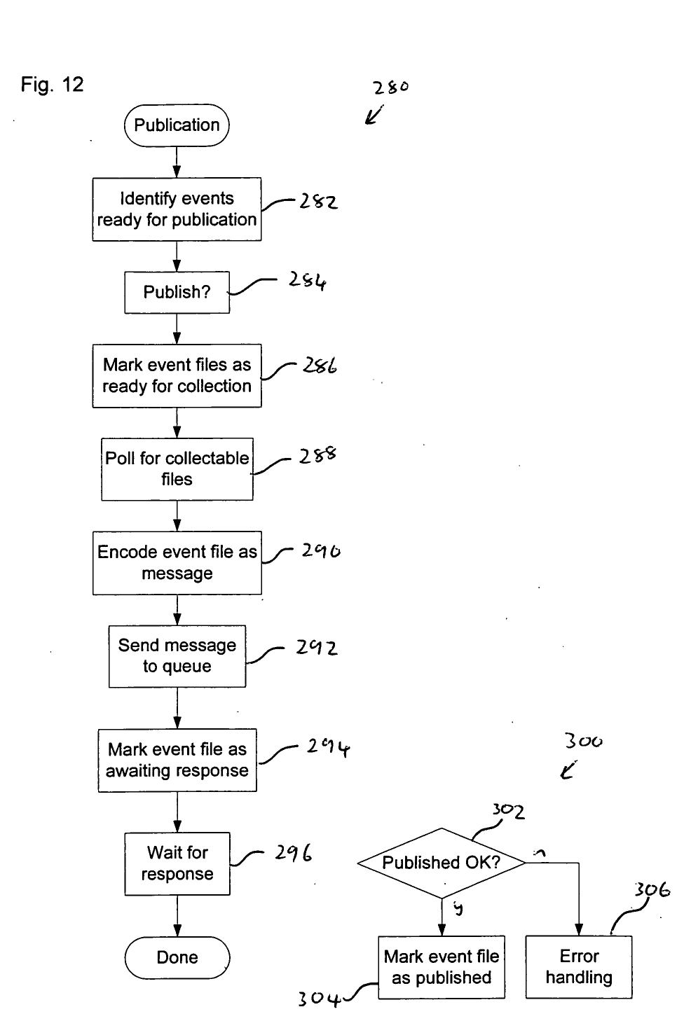

FIG. 12 shows a process flowchart illustrating a publication method 280 carried out by a process running on the application server. At step 282, the process identifies those event records which have been flagged as ready for publication. At step 284, the process waits until a command has been entered to cause the event record to be published to be included in the index. At step 286, a flag is set for each event file ready for collection for publication. At step 288, the application server is periodically polled to determine whether there are any files ready for collection. Then at step 290, when the application server is next polled, the event file data for those files marked ready for collection is encoded as a message. In particular, the XML file is encoded as an MSMQ message and at step 292 the encoded message is sent to an MSMQ message queue on the database server 124. Then at step 294, the application server process marks the event file as awaiting a response indicating whether the file has been published. At step 296, the publication process 280 waits for the publication response.

A publication response process 300 determines whether the publication server has received an indication that the event record has been published. If so, then a flag is set indicating that the event file has been published. If an indication is received that the event file has not been published, then an error handling routine 306 is called. Error handling can include setting data in the publication response to indicate that the file has not been published and that the file requires further editing or correction.

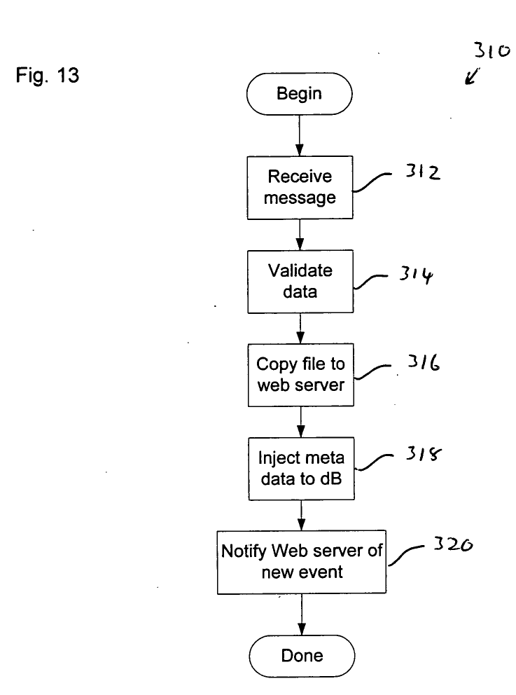

FIG. 13 shows a process flowchart illustrating a part of the publication process 310 carried out in parallel on live database server 133. At step 312, the live database server receives the encoded MSMQ message. Then at step 314, the live database server decodes the MSMQ message and validates the received XML data to determine whether the data was corrupted during transfer or not. If the data does not validate, then a message is sent to the application server 122 notifying the error. If the data has been validated then at step 316 the XML data file is copied to web server 132 and the metadata for the event record is stored in database 126. At step 320, the live database server notifies the web server of the existence of a new or updated event record which can be published. The publication process then terminates.

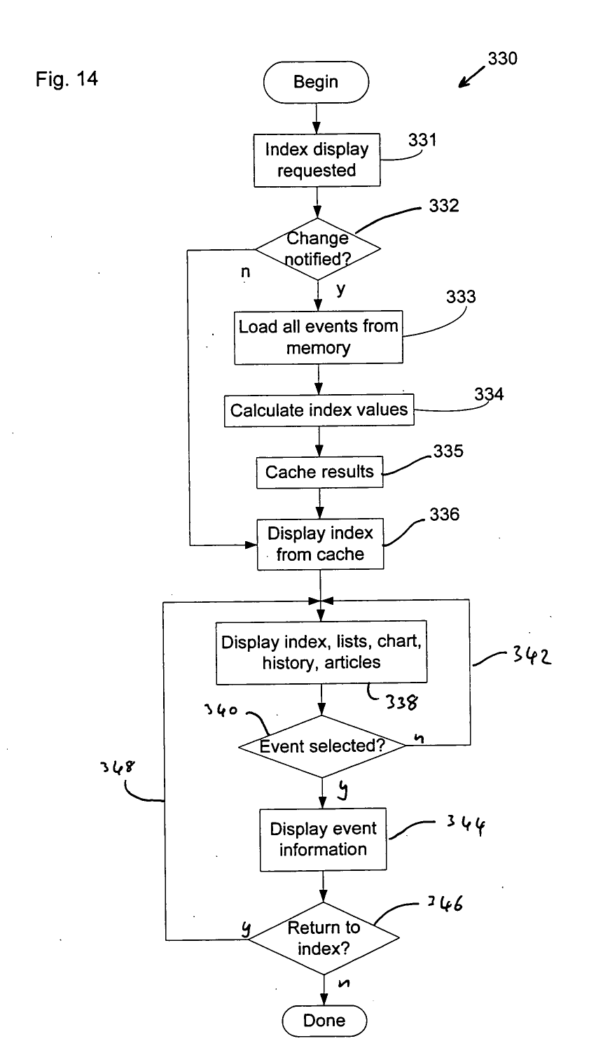

FIG. 14 shows a process flowchart illustrating a method 330 of making the global economic index available to a user. The global economic index is provided as a feature of a website of a global political publication. It will be appreciated that the index includes events which can be characterised broadly as being financial, macroeconomic or political. However, the index can include any type of event which is generally likely to affect the global economy, or other political, commercial or societal system, such as military or security events. The index can either be displayed on the home page, or in freely available pages or alternatively can be provided only to registered users of the website via a log in protocol. A user can view the index via suitable browser software operating on user computer 140. As will be well understood in the art, web server 132 transmits web pages for display using the browser over the internet 138 in response to requests transmitted from the user computer 140.

The index display method 330 takes no action until a command is entered indicating that the index is to be displayed 331. Then it is determined if a notification of a change in the values used to calculate the index has been received (corresponding to step 320 of FIG. 13). If not then processing proceeds to step 336. However, if the web server has been notified that some of the event data has been updated, then at step 333 data for all of the events is loaded into memory of the web server from the live database server and at step 334 the index value is calculated and all other data required for generating graphical displays, etc is generated.

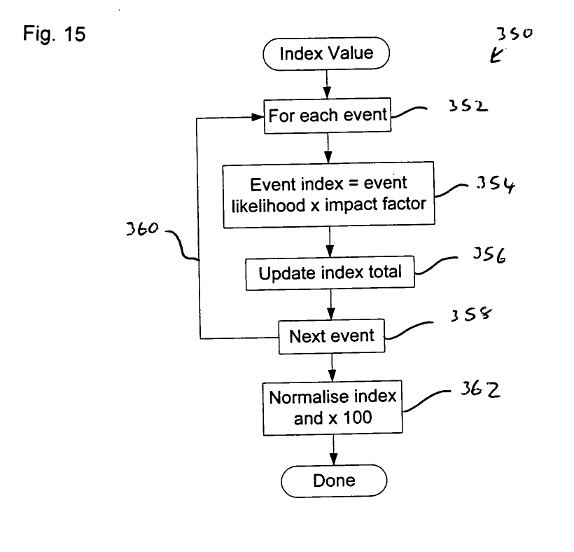

FIG. 15 shows a flowchart illustrating an index calculation method 350 corresponding generally to step 336. At step 352, a first event is selected and the contribution to the overall index from that event is calculated at step 354 by multiplying the likelihood of the event by the impact factor for the event. Event index values are calculated using both the one year likelihood and also the five year likelihood. The value for the current event index is added to the index total at step 356. Then at step 358, if any events have not yet been processed, processing returns to step 352, as illustrated by process return line 360 and the event index value for the next event is calculated. Processing loops until event index values for all of the events constituting the index have been calculated. Then at step 362, the index total is “normalised” and then multiplied by 100, to provide a “percentage” value.

However, it will be appreciated that this is not a true percentage because of the “normalisation” carried out. The index is normalised by dividing the total of the event indexes by the sum of the impact factors for all of the events in the index. This provides a numerical value between 0 and 1 which is multiplied by 100 to provide an effective “percentage” which is quoted as the index value.

In other embodiments a subset of the most important events can be used to normalise the index. For example, only those event for which the product of their likelihood and their impact factor exceeds a cut off or threshold value can be used. The sum of the impact factors for those events is then used to normalise the index.

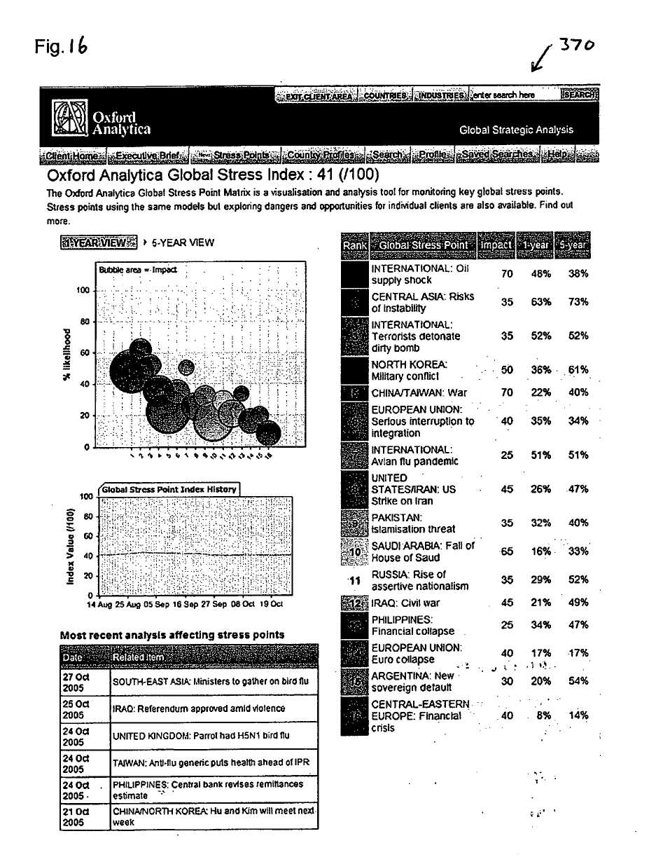

Returning to FIG. 14, the results are then cached locally to the web server at step 335. Then at step 336 the index is displayed using the values from the cache. Hence, if there has been no change to the event data since the index values were last calculated, then the locally cached values are used. At step 338, the dynamically calculated index and event values are used to allow the index and various graphical representations of the index and events to be displayed to the user. FIG. 16 is a screen shot of a web page 370 displaying the global economic index. The index, which in this example has a value of 41 is displayed. The web page also shows a bubble graph illustrating the sixteen events constituting the index. For each event, the centre of the bubble corresponds to the likelihood of the event and the area of the bubble corresponds to the impact of the event. Details of each of the sixteen events contributing to the index are provided in a table which provides a title for each event, value of the impact factor for each event and the one year likelihood and the five year likelihood expressed as percentages. A graphical representation of the historical value of the global economic index is also displayed, showing the variations in value of the index with time over a particular period. A table listing analyses of recent incidents which may have influenced the values of the drivers or restrainers for the events is also displayed. The user can select to read executive summaries by simply selecting the analysis headlines. The user can also select to display the index based on five year likelihood values by selecting a five year view button in which case the index is re-displayed using the five year values instead.

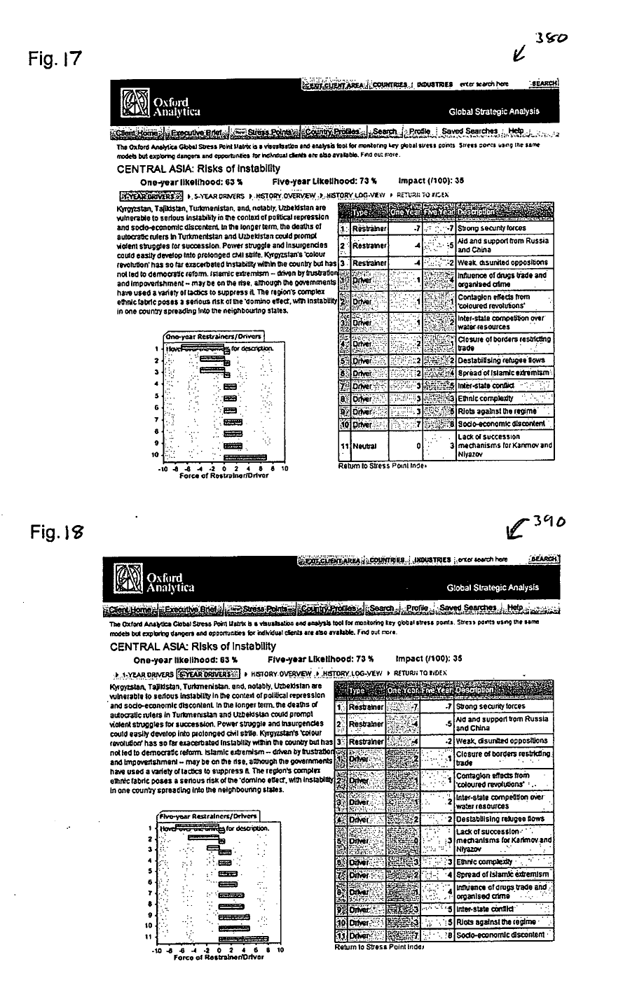

If a user selects to display further information relating to any of the events, by clicking on the title of the event in the event table, then processing proceeds to step 344 at which information relating to the selected event is displayed to the user. FIG. 17 shows a screen shot of a web page 380 displaying event information for the second event of the index. The title of the event is displayed showing a textual summary. The one year likelihood value and five year likelihood values are also displayed together with the impact of the event. A table is also displayed listing the factors relating to the event, an. indication whether each factor is a restrainer, driver or neutral (which is also colour coded) and the numerical values of each factor on a one year basis and five year basis together with a description of the factor. A graphical representation of the factors is also provided in the form of a bar chart. By selecting a five year drivers button, the bar chart is re-displayed using the five year restrainer/driver values, as illustrated by screen shot 390 shown in FIG. 18.

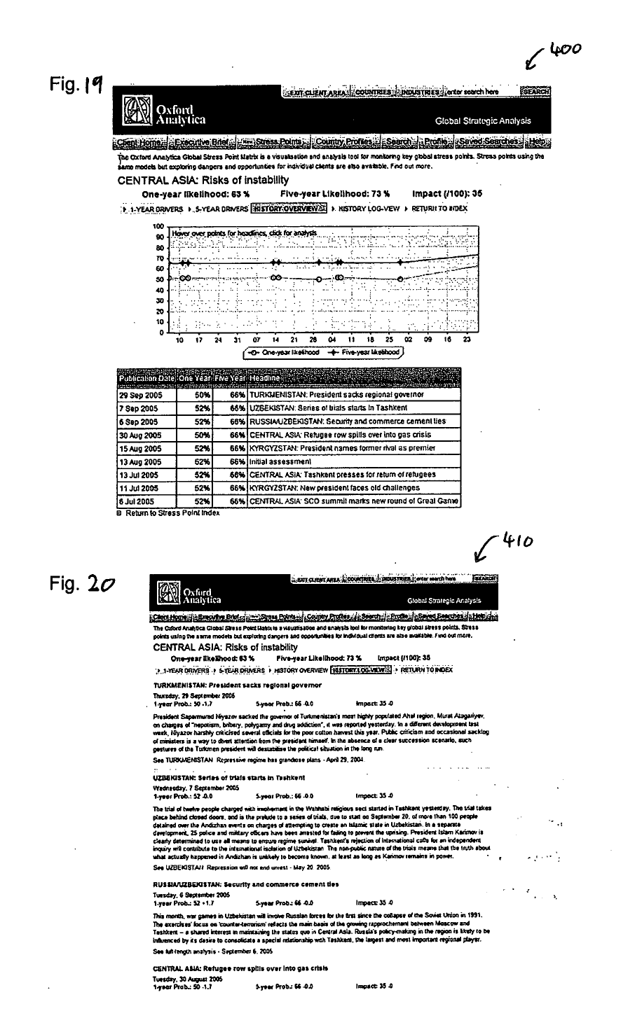

A user can also select to view an overview of the history of the event by selecting a history overview button. FIG. 19 shows a screen shot of a web page 400 illustrating the history overview page. A graphical representation of the one year likelihood and the five year likelihood as a function of time is displayed together with a table summarising historical incidents which may have influenced the driver/restrainer values. The user can select to view an executive summary of any of the incidents by selecting the headline in the overview table.

The user can also select to view a historical log of the incidents which have influenced the values of the drivers or restrainers. FIG. 20 shows a screen shot of the historical log page 410. The historical log page includes the title of the analysis for each incident, an executive summary of the incident, and the date of publication of the analysis and the one year and five year likelihoods at the current point in time. Where appropriate a link is also provided to a more detailed analysis relating to the incident. The user can also select to return to the overview of the index as illustrated in FIG. 16. If the user selects to return to the index page, then processing returns as illustrated by line 348 and the index overview page 370 is re-displayed. Otherwise, the user can select to view any of the other pages or exit.

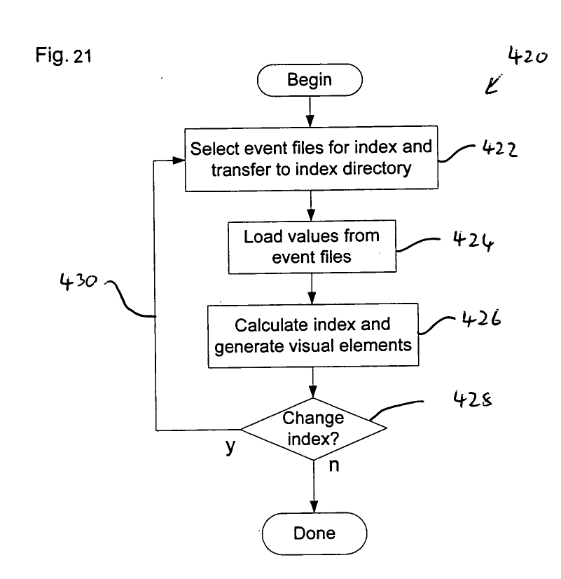

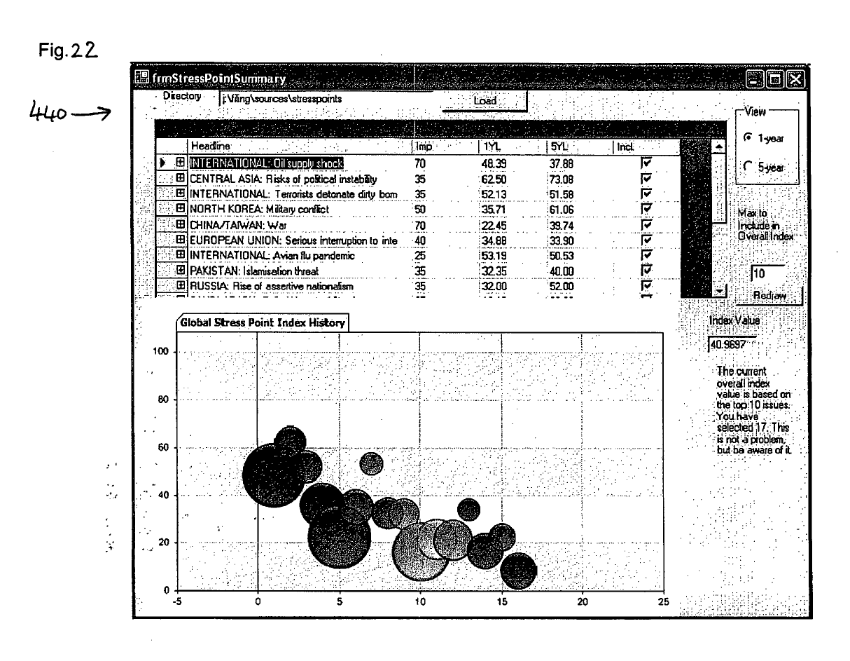

FIG. 21 shows a process flow chart illustrating a non-publication based method for displaying the index. This process is used in the internal or consultancy environments to display the index. Prior to displaying the index, event records are created for each of the events to be potentially included in the index using the event editor described previously and storing the event records in a local file store. The index display 420 begins by selecting the event files for each of the events constituting the index. FIG. 22 shows a screen shot 440 of an index display tool for carrying out index display method 420. A table listing the available event records is provided including the title of each event, the impact factor for each event, the one year likelihood and the five year likelihood. A tick box is also provided allowing the user to select the event record for inclusion in the index. Those event records to be included in the index are selected and the event records are transferred to a specific directory from which the index value is calculated. When a command is entered to calculate the index, at step 424, the likelihood and impact factors are loaded into local memory at step 426 and the index value is calculated using the same method as described previously.

A graphical representation of the index and events can also be generated and displayed to the user. For example as illustrated in FIG. 22, as well as displaying the current index value, a graphical representation of the events comprising the index is also provided in the form of a bubble graph. The position of each bubble represents the likelihood of each of the events and the size of each bubble represents the impact of each event. At step 428, the user can select to change the index by selecting to include a different number or different combinations of events in the sub group of events constituting the index. The user can also select to view the five year index rather than one year index by selecting appropriate radio buttons and generating a command to recalculate the index and re-display the bubble graph. After review of the index has been completed, then the user can select to exit the tool and processing ends.

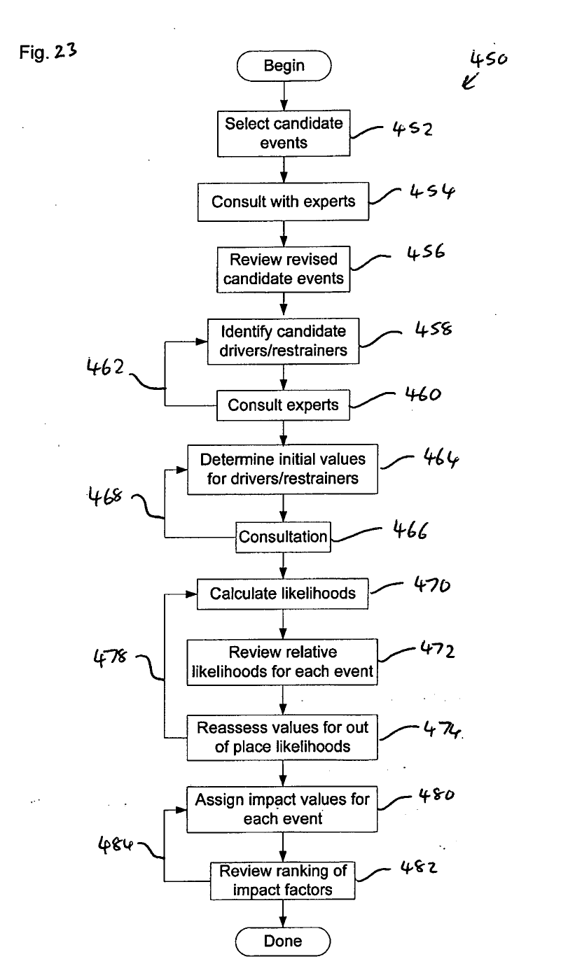

Having described the software tools and environments in which the invention can be used, the creation of the global economic index will be described in greater detail. FIG. 23 shows a flowchart illustrating a method 450 for setting up the index. The organisation responsible for administering the index includes a number of employees who work on the index, such as editors of the online publication, regional heads responsible for different regions covered by the publication and external experts who write articles for the publication, such as academics, industrialists, government officials and government advisers. At step 452, an individual or group of individuals responsible for the index select an initial group of candidate events to comprise the index. Then at step 454 a consultation process is carried out regarding the set of candidate events. In particular, the editors of the publication which are most closely involved with each of the events or other experts in the field, are consulted with to assess the suitability of the events that have initially been identified.

The events are preferably defined by a specific question, such as “what is the likelihood of event x occurring?”. The consultation with the experts can involve a more narrow definition of the events and/or events being added or removed from the candidate set of events. After the consultation stage 454, at step 456, the revised set of candidate events is further reviewed until the set of candidate events has been settled. Once the set of events constituting the index has been settled upon, the next general step of the method is to agree the factors, that is the drivers and restrainers, for each event.

At step 458, potential or candidate factors are identified for each of the events. This involves trying to identify the main pressures that would likely lead to the event happening or not within the time frame. This may include historical data based on past occurrences or speculation as to potential future occurrences. Once the candidate drivers/restrainers have been identified, then a consultation process is carried out at step 460. This can include reviewing the candidate drivers/ restrainers with the editors and regional heads to determine whether the drivers/restrainers identified are appropriate, whether further factors need to be included and/or whether any of the candidate factors should be removed. The consultation stage 460 can be an iterative process, as illustrated by return loop 462 and can include several rounds of consultation until the drivers/restrainers for each event have been settled.

Once the factors have been settled for each event, at step 464, initial values for each of the factors, and for each of the events, are determined. After initial proposed values for each factor have been determined, then a consultation stage 466 occurs at which the initial values are reviewed with experts in the appropriate area to determine whether the proposed values are reasonable. This can include discussions with editors, regional heads and external experts, such as those who contribute detailed articles to the publication. In determining the initial values for the factors, it is the relative values of the factors which is more important than their magnitudes. Therefore as part of the consultation process it is important to ensure that the quantitative values selected for the drivers and restrainers accurately reflect the relative likelihood of the driver or restrainer. It is also important that the value of the factor accurately represents the current real world state and is based on up to date information.

Once the quantitative values have been settled, then at step 470, the software tools described above are used to calculate the likelihoods of each event at step 470. Then at step 472, a review process is carried out to ensure the internal consistency of the calculated likelihoods. That is, the relative likelihoods of each event are compared to ensure that they reflect the perception of the current situation by the experts in the field. At step 474, if any of the likelihoods are considered to be inconsistent, then the quantitative values for the factors for that event can be reassessed at step 474 and the likelihoods recalculated at step 470. As illustrated by return line 478, this can also be an iterative process in which the relative likelihoods are reassessed until they are considered to be consistent with each other.

Once the initial likelihoods have been settled, then at step 480, impact values are assigned to each of the events. Any scale of impact values can be used, but preferably an impact value in the range from 0 to 100 is used with 0 indicating no impact on the global economic situation and an impact value of 100 indicating the most significant possible impact on the global economic situation. For example an event such as the Wall Street crash might be assigned an impact value of 70 reflecting the consequences of such an event on the global economy. After initial impact values have been assigned to each event, the ranking of the impact factors is reviewed at step 482 to ensure consistency of the impact values. That is, the impact values are reviewed to ensure than an event which is considered to have less of an impact on the system than another event does not have a higher impact factor value. Again, this can be a consultation process with experts involved and can also be an iterative process as illustrated by return line 484. Once the impact factors have been settled, then the method of initially creating the index ends.

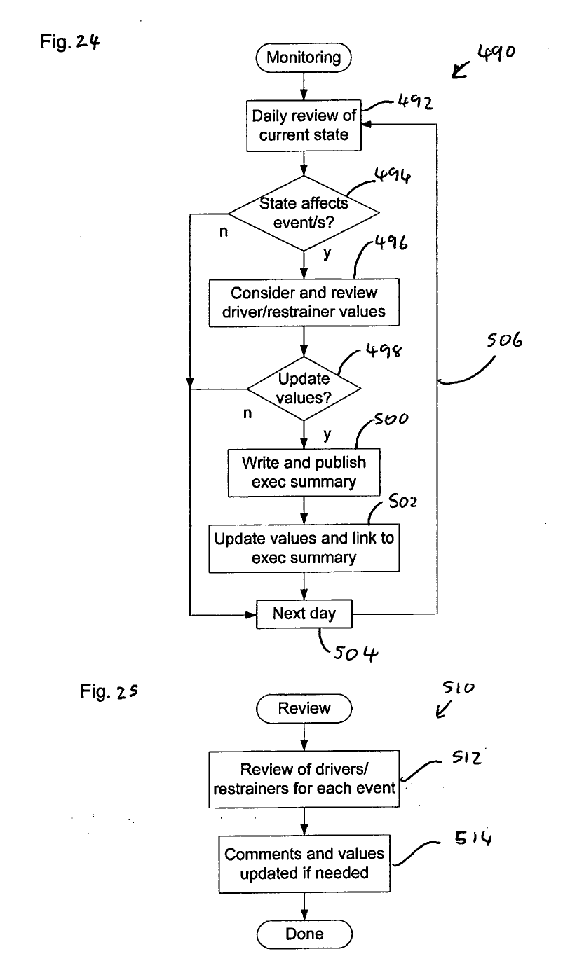

This allows an initial value of the index to be calculated using the initial values of the drivers and restrainers. However, it is important that the values of the drivers and restrainers are monitored on a regular, periodic basis to ensure that they accurately reflect the current status or world situation. FIG. 24 shows a flowchart illustrating a method of monitoring the driver/restrainer values 490. A daily review of the current state of the world is carried out as part of a daily editorial meeting of the publication. At step 494, it is determined whether anything that has happened is likely to effect any of the events on the index. If not, the monitoring process ends until the next day 504 when the review of the current state is repeated 506 at step 492. If it is determined that something may influence one of the events of the index, then at step 496 the current values of the factors for the event are considered to determine whether the numerical values of any of the factors should be increased or decreased to more accurately reflect the current situation surrounding the event. If it is determined at step 498 that none of the values do need updating, then the monitoring process ends for this day and is continued again on the next day 504.

However, if it is determined that the current situation does require at least one value to be updated, then at step 500 an executive summary of the situation requiring the change in values is written and published through the online publication. Then at step 502, the event editor tool is used to update the value of the driver/restrainer and a link is generated from the index overview page to the executive summary which has been published. The updated event record is then marked for publication and published on the website as described previously. The monitoring process then ends for that day and begins again on a next day 504 as illustrated by return line 506. This process then continues with the situation of the world being monitored on a daily basis to determine whether the driver/restrainer values need updating to more accurately reflect the current status. In this way the index is kept current and takes into account the current world situation more accurately. It will be appreciated that different review periods can be used, e.g. weekly, monthly. However daily reviews are preferred in order to ensure the currency of the index.

As well as a daily review of the driver/restrainer values, a higher level review of the index is also carried out on a periodic basis. FIG. 25 shows a flowchart illustrating the review method 510. A review committee for the publication carries out a review of the index on a periodic basis, for example fortnightly. The review committee may include the editors and the regional heads for the publication. External experts may also be part of the review committee. At step 512, the current values for the drivers and restrainers for each event for that day are reviewed, together with the articles to be published on that day. The values of the drivers/restrainers are reviewed in the context of the articles and also the knowledge of the persons on the committee to determine whether the drivers or restrainer values appear appropriate and to identify any changes that may be required. Comments on the values and suggested changes on the driver/restrainer values are then returned to the responsible editor who determines whether to make the changes recommended by the review committee. If so, then the event record editor tool is used to change the driver/restrainer values and make any changes to the accompanying article or summary. Hence in this way, an independent overview of the index is provided to help prevent non-uniformity of application of the criteria of the index.

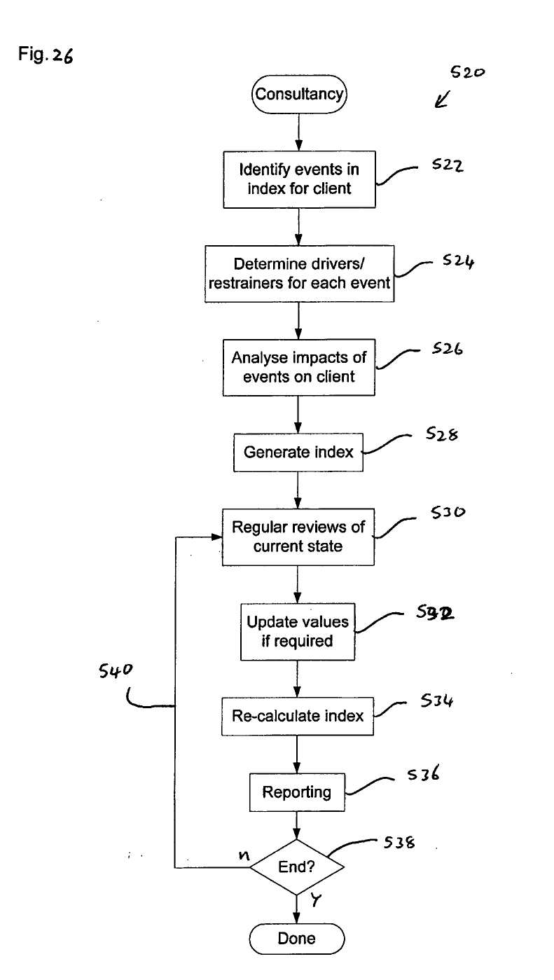

The above discussion has focussed on the publication environment in which the invention can be used. With reference to FIG. 26 there is shown a flowchart illustrating a method for using the invention in a consultancy environment. Under the consultancy method, an organisation familiar with the methodologies for creating an administering the index provides a consultancy service to an organisation to help establish and administer an index of use to the organisation in helping to forecast the future of a system of interest to the organisation.

At step 522, the consultants work with individuals from the organisation to identify potential events to be included in the index in a manner similar to that described above in the publication model. Once the set of events has been settled, then at step 524, the consultants again work with the organisation to determine potential drivers and restrainers for each event and determine initial values for each of the drivers and restrainers. Again this is a consultative process with the client organisation taking advantage of the internal expertise of the client organisation and any external source of expertise.

Then at step 526, impact factor values for each events are determined by analysing the likely impact of each of the events on the system of interest to the client or organisation. Again this may be a consultative process with the client organisation and may involve internal and external sources of expertise. Then at step 528, an initial value for the index is generated using the forecasting software tools described above and an initial value of the index and related information can be supplied to the client.

At step 530, a periodic review of the current state of things may require changes to the driver/restrainer values is carried out. Either internally by the organisation or by the consultants. If it is determined that driver/restrainer values need updating, then the editor software tool is used to update the driver/restrainer values at step 532 and at step 534 the index value is recalculated. At step 536, the recalculated index value can be reported to the organisation, or is made available to the organisation, if recalculation of the index is carried out internally. Reporting may be carried out on a regular periodic basis or instead may be triggered by the index meeting a pre-determined criteria. For example the index falling above or below a threshold value may trigger a particular report. Alternatively, the index changing by a pre-determined amount, e.g. increasing or decreasing by 5%, may also be used to trigger a particular report. Reporting may include more than simply reporting the value of the index. Reporting may include a detailed analysis of the change in a situation which has caused the pre-determined variation in the index. The report may also include suggested course of action or agreeing a course of action to be taken by the organisation in the event of the pre-determined change of the index. Taking action as a result of the change in the index value may help prevent an undesired consequence occurring to the organisation, thereby mitigating the effect of a changed situation in future on the organisation.

If the monitoring of the index is determined to be ongoing at step 538, then as illustrated by return line 540, the current situation is repeatedly monitored and the index value regularly reported. Alternatively, it may be determined that the index is no longer required and the method may end. The method may include other stages, including an overview or review process similar to that used in the publication environment to ensure the consistency of application of the methodology. The method may also include periodic reviews to determine whether the restrainers/drivers should be changed and also whether the events needs changing or new events adding or current events removing from the index. Different combinations of events may also be used for generating the index. A check of the impact factors depending on the evolution of the organisation may also be carried out to ensure that the impact factors accurately reflect the consequences of any of the events occurring.

While FIG. 26 has described a consultancy method 520, it will be appreciated that the methodology of the present invention and software tools may also be used by an organisation themselves in an internal or an analytical approach in which the organisation creating and administering the index is the same organisation for which the index is produced or is of relevance. For example a commercial organisation may create its own index to help forecast the impact of events on its business. A financial institution may create and administer its own index to help forecast events influencing financial markets or financial systems. Similarly, a military, security or intelligence organisation may use the invention. As will be appreciated the present invention has a wide range of application which is not intended to be limited only to the fields of application specifically mentioned.

Generally, embodiments of the present invention employ various processes involving data stored in or transferred through one or more computer systems. Embodiments of the present invention also relate to an apparatus for performing these operations. This apparatus may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialised apparatus to perform the required method steps.

In addition, embodiments of the present invention relate to computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium. Examples of program instructions include both machine code, such as produced by a compiler, and files containing higher level code that may be executed by the computer using an interpreter. Although the above has generally described the present invention according to specific processes and apparatus, the present invention has a much broader range of applicability. In particular, aspects of the present invention is not limited to any particular system and can be applied to virtually any complex system where a quantitative measure of the state for the system which can be used to forecast the behaviour of the system would be of benefit. One of ordinary skill in the art would recognize other variants, modifications and alternatives in light of the foregoing discussion.

What is claimed is:

1. A method for creating a quantitative index indicating the current state of a system which may be affected by a plurality of events, the method comprising:
for each of said plurality of events, assigning a numerical value to each of a plurality of factors identified as influencing the event, wherein the numerical value is based on the current situation;
for each of said plurality of events, using the numerical values to calculate a likelihood metric for the event occurring; and
for each of said plurality of events, combining an impact factor value and the likelihood metric, wherein the impact factor value indicates the impact that the event occurring would have on the system, to calculate the quantitative index.

2. The method as claimed in claim 1, wherein the sign of the numerical value indicates whether the factor drives the event to happen or restrains the event from happening.

3. The method as claimed in claim 2, wherein calculating the likelihood of the event occurring includes dividing the sum of positive numerical values for the event by the sum of the absolute values of the numerical values for the event.

4. The method as claimed in claim 1, wherein calculating the quantitative index further includes normalising the quantitative index.

5. The method as claimed in claim 4, wherein calculating the quantitative index includes multiplying the impact factor value and likelihood for each of the plurality of events.

6. The method as claimed in claim 4, wherein normalising the quantitative index includes using a maximum value for the index corresponding to all of the events occurred.

7. The method as claimed in claim 1, and further comprising:
monitoring the current situation;
identifying changes in the current situation which require numerical values for any of the factors for any of the events to be updated and updating those numerical values; and
recalculating the quantitative index using the updated numerical values.

8. The method as claimed in claim 1, wherein the system is selected from the group of systems comprising: political; industrial; economic; financial; social; military; security; and defence.

9. The method as claimed in claim 1, and further comprising:
for each of said plurality of events, assigning a further numerical value to each of the plurality of factors;
for each of said plurality of events, using the further numerical values to calculate a longer term likelihood of the event occurring; and
for each of said plurality of events, combining an impact factor value and the longer term likelihood, to calculate a further quantitative index.

10. The method as claimed in claim 1, and further comprising:
for at least one of the plurality of factors, assigning a numerical value to each of a plurality of sub-factors identified as influencing the factor; and
determining the numerical value for the factor from the numerical values for the sub factors.

11. A computer implemented method providing a forecasting tool for creating a quantitative index indicating the current state of a system which may be affected by a plurality of events, the method comprising:
calculating a likelihood of each of the plurality of events occurring using, for each of the plurality of events, numerical values assigned to each of the plurality of factors identified as influencing the event and wherein the numerical values are based on the current situation;
combining an impact factor value assigned to each event and the likelihood of each event to provide an impact metric for each of the events, wherein the impact factor value indicates the impact that the event occurring would have on the system; and
calculating the quantitative index by combining the impact metrics for all of the events.

12. The method as claimed in claim 11, in which each numerical value has a sign which indicates whether the factor drives the event to happen or restrains the event from happening.

13. The method as claimed in claim 12, wherein calculating the likelihood of the event occurring includes dividing the sum of the numerical values for the drivers for the event by the sum of the absolute values of the numerical values for the event.

14. The method as claimed in claim 11, wherein calculating the quantitative index further includes normalising the quantitative index.

15. The method as claimed in claim 11, wherein calculating the quantitative index includes multiplying the impact factor value and likelihood for each of the plurality of events.

16. The method as claimed in claim 13, wherein normalising the quantitative index includes using a metric of the total impact on the system if all of the events occurred.

17. The method as claimed in claim 11, and further comprising:
recalculating the quantitative index using updated numerical values, wherein the updated numerical values relate to any of the factors for any of the events which have been updated to reflect changes in the current situation.

18. The method as claimed in claim 11, and further comprising:
for at least one of said plurality of events, assigning a further numerical value to each of the plurality of factors identified as influencing the event;
for said at least one of said plurality of events, using the further numerical values to calculate a longer term likelihood of the event occurring; and
for said at least one of said plurality of events, combining an impact factor value and the longer term likelihood, to calculate a further quantitative index.

19. A data processing apparatus providing a forecasting tool for creating a quantitative index indicating the current state of a system which may be affected by a plurality of events, the data processing apparatus including at least one data processing device and at least one storage device, the storage device storing computer program instructions which can configure the data processing apparatus to:
calculate a likelihood of each of the plurality of events occurring using, for each of the plurality of events, numerical values assigned to each of the plurality of factors identified as influencing the event and wherein the numerical values are based on the current situation;
combine an impact factor value assigned to each event and the likelihood of each event to provide an impact metric for each of the events, wherein the impact factor value indicates the impact that the event occurring would have on the system; and
calculate the quantitative index by combining the impact metrics for all of the events.

20. A computer program product comprising at least one computer readable medium bearing computer program instructions for providing a forecasting tool for creating a quantitative index indicating the current state of a system which may be affected by a plurality of events, the computer program instructions comprising computer program instructions to:
calculate a likelihood of each of the plurality of events occurring using, for each of the plurality of events, numerical values assigned to each of the plurality of factors identified as influencing the event and wherein the numerical values are based on the current situation;
combine an impact factor value assigned to each event and the likelihood of each event to provide an impact metric for each of the events, wherein the impact factor value indicates the impact that the event occurring would have on the system; and
calculate the quantitative index by combining the impact metrics for all of the events.

21. A method for creating a quantitative index reflecting the current global economic state, wherein the global economic state may be affected by a plurality of events, the method comprising:
for each of said plurality of events, assigning a numerical value to each of a plurality of factors identified as influencing the event, wherein the numerical values are based on the current situation;
for each of said plurality of events, using the numerical values to calculate a likelihood of the event occurring; and
for each of said plurality of events, combining an impact factor value and the likelihood, wherein the impact factor value indicates the impact that the event occurring would have on the global economic state, to calculate the quantitative index.

22. The method as claimed in claim 21 and further comprising:
monitoring the current situation on a periodic basis to identify any changes which may require any of the numerical values for any of the factors for any of the events to be updated.

23. The method as claimed in claim 22, wherein monitoring the current situation is part of a daily editorial process for an online publication relating to the global political situation.

24. The method as claimed in claim 22, and further comprising:
updating the numerical values identified as requiring updating; and
recalculating the quantitative index using the updated numerical values.

25. The method as claimed in claim 21, and further comprising:
periodically reviewing the current numerical values to identify any numerical values appearing inaccurate; and
considering whether to change the numerical values identified as appearing inaccurate.

26. The method as claimed in claim 21, and further comprising:
identifying a plurality of candidate events which may be relevant to the global economic state; and
using experts to assesses the candidate events to identify the plurality of events to be used in determining the quantitative index.

27. The method as claimed in claim 21, and further comprising:
identifying a plurality of candidate factors which may affect a one of the plurality of events; and
assessing the plurality of candidate factors to identify the plurality of factors to be used in determining the quantitative index.

28. The method as claimed in claim 24, and further comprising publishing online an article relating to the change in the current situation which required the numerical value to be updated.

29. The method as claimed in claim 21, further comprising publishing the historical changes in the quantitative index.

30. The method as claimed in claim 21, and further comprising:
assigning a further numerical value to each of the plurality of factors identified as influencing the event;
for each of said plurality of events, using the further numerical values to calculate a longer term likelihood of the event occurring; and
for each of said plurality of events, combining an impact factor value and the longer term likelihood, to calculate a further quantitative index.

31. A consulting method for determining a quantitative index reflecting the current state of a system of relevance to an organisation, comprising:
consulting with the organisation to identify at least one event which is likely to affect the state of the system:
consulting with the organisation to identify a plurality of factors likely to influence the event;
assigning a numerical value to each of the plurality of factors;
using the numerical values to calculate a likelihood of the event occurring;
combining an impact factor value and the likelihood, wherein the impact factor value indicates the impact that the event occurring would have on the system, to calculate the quantitative index; and
reporting the quantitative index to the organisation.

32. The method as claimed in claim 31, and further comprising monitoring the current situation to determine if any of the numerical vales need updating to more closely reflect the current situation, and if so then updating the numerical values and calculating the quantitative index using the updated numerical values.

33. The method as claim in claim 32, and further comprising monitoring changes in the quantitative index and notifying the organisation of any changes in the quantitative index corresponding to a pre-determined criterion.

34. The method as claimed in claim 33, and further comprising carrying out an ancillary action for the organisation in response to any changes in the quantitative index corresponding to a predetermined criterion.

35. The method as claimed in claim 34, wherein the ancillary action is selected from the group comprising: researching the change in the current situation; analysing the change in the current situation; advising on the change in the current situation; identifying pre-emptive action for the organisation intended to mitigate the change in the quantitative index.
